(19) United States
(12) Patent Application Publication
(10) Pub. No.: US 2026/0338448 A1
(43) Pub. Date: Oct. 29, 2026

(54) ANTI-ICING SYSTEM

(71) Applicant: Tusas- Turk Havacilik Ve Uzay Sanayii Anonim Sirketi, Kahramankazan, Ankara (TR)

(72) Inventors: Burhan SAHIN, Kahramankazan, Ankara (TR); Alparslan ILBAS, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/107,145

(22) PCT Filed: Aug. 22, 2023
(86) PCT No.: PCT/TR2023/050841

§ 371 Date: Feb. 27, 2025

(30) Foreign Application Priority Data
Aug. 31, 2022 (TR) 2022/013606

(51) Int. Cl. F25C 5/06; B64D 15/16; B64D 15/22; F03D 80/40

(52) U.S. Cl. CPC F25C 5/06; B64D 15/16; B64D 15/22; F03D 80/403

(57) ABSTRACT

The present invention relates to a body (2); at least one wing (3) located on the body (2); at least one icebreaker (4) on the wing (3), which enables the ice formed on the wing (3) surface to be removed from the wing (3) surface; an actuator mechanism (5) that enables the icebreaker (4) to move on the wing (3).

This invention relates to an anti-icing system that enables the ice formed on the wing surface to be removed from the wing.

Body and wings of an air vehicle are designed to be aerodynamically smooth. This provides unhindered airflow around the wings. The vapor and liquid moisture in the air cools down on the wing surface, causing ice formation. Especially in the wing profile, icing is encountered intensely on the upper and leading-edge regions. It is known that icing on the wing surface disrupts the structure of the wing profile, negatively affects the formation of aerodynamic forces and increases the weight of the wings. In order to prevent the risks caused by icing, many systems have been developed to remove ice from the wings.

U.S. Pat. No. 9,120,567B2, which is included in the known-state of the art, discloses a mechanism provided on the blade to increase the leveling speed of helicopters. As the blade rotates, the air received into the blade through the air inlet opening under the influence of centrifugal force moves through the channel, which is then evacuated through the second air opening located on the attack zone. In this way, the maximum lift provided by the blades is increased.

GB518463A, which is included in the known-state of the art, discloses a system for breaking ice layers formed on airplane wings. According to said system, the ice formed on the wing surface is broken when the material made of rubber on the wing expands by being inflated with a liquid transmitted over the air vehicle. When a pressurized air is sent into the rubber tube, the elastic tube inside the wing expands and the vibrations formed on this structure due to air flow can be used to remove the ice.

GB523108A, which is included in the known-state of the art, discloses a system that aims to prevent icing in a wing area of an air vehicle or to prevent ice formation with mechanical structures placed under the leading edge of the wing. There are cams, which are moved and controlled to be located in the internal structure of the wing, behind the leading edges having a layer of rubber thereon. Ice formation on the surface can be prevented by cams applying a periodical force to the rubber surface through the wing, and the ice layers on the surfaces can be broken and removed.

U.S. Pat. No. 10,392,116B2, which is included in the known-state of the art, discloses a system that aims to remove ice formation on the wing by triggering the ice with hydraulic or pneumatic methods and generating shock vibrations. After a fluid is removed by vacuum from a space, in which it is conveyed, a shock pulse can be created in an area between an erosion shield and the air vehicle, so that the ice layers are broken.

An anti-icing system according to the present invention with a high-strength, which prevent deterioration of the wing structure, enables thick layers of ice to be easily removed from the wing surface.

Another object of the present invention is to enable removal of ice from the wing in a short period by mechanically breaking the ice.

The anti-icing system according to the present invention, which is defined in the first claim and other claims dependent thereon, comprises a body on which a rotary wing or a fixed wing is mounted; an actuator mechanism mounted on the wing in different numbers and sizes, depending on the wing dimensions and user requirements, in order to remove the ice, which is formed on the wing due to the effect of cold air, from the wing.

The anti-icing system according to the invention comprises a first position (I) in which an icebreaker installed within a leading edge of the wing creates an aerodynamic surface corresponding to the leading edge of the wing; the second position (II) in which the icebreaker mechanically breaks the ice formed on the wing surface and removes it from the wing with the effect of aerodynamic friction, and extends outward from the leading edge of the wing (II); at least one air inlet as an opening in the wing, which allows air inlet; and the actuator mechanism which enables the icebreaker to move from the first position (I) to the second position (II) if the ice formed on the wing is desired to be broken mechanically, which enables the air received from the air inlet to trigger the icebreaker to retract the icebreaker from the second position (II) to the first position (I) into the leading edge of the wing to restore the wing surface, and which enables the icebreaker, consisting of air duct, air inlet and air duct, to move between the first position (I) and the second position (II). The heat generated by the friction and friction effect caused by movement also have an impact in de-icing the wing, and such a heat can be transferred to the entire wing made of conductive materials.

In an embodiment of the invention, the anti-icing system comprises a plurality of consecutive openings made by the manufacturer on the leading edge of the wing; a plurality of consecutive extensions on the icebreaker, which are arranged by the manufacturer to correspond to the openings. The opening and the extension are form-compatible with each other on the leading edge of the wing, and form an almost identical aerodynamic surface when the icebreaker is in the first position (I). When the icebreaker is triggered by the actuator mechanism, it moves outwards from the leading edge of the wing to be brought to the second position (II), the extensions move outwards from the leading edge of the wing to break the ice. After the ice is broken, the icebreaker moves back to the first position (I).

In an embodiment of the invention, the anti-icing system comprises a cover on the air inlet, which enables adjustment of the amount of air delivered to the air duct through the air inlet, thus allowing the movement of the icebreaker between the first position (I) and the second position (II) to be controlled. The cover can be opened and closed using a trigger. When the cover is opened by the trigger, the air received from the air inlet is transferred through the air duct to allow the icebreaker to move from the first position (I) to the second position (II). When the cover is triggered and closed by the trigger, the air intake through the air inlet is prevented, and the icebreaker is enabled to move from the second position (II) to the first position (I). The cover and trigger allow control of the air flow rate delivered to the air duct.

In an embodiment of the invention, the anti-icing system comprises a third position (III) which allows the icebreaker to move from the first position (I) to the second position (II) with the air received from the air inlet in order to break the ice, wherein the cover has the third position (III) when opened by the trigger; a fourth position (IV) in which the air inlet closes the cover by means of the trigger to prevent air from entering the air duct. When the cover is in the fourth position (IV), the icebreaker is in the first position (I), and when the cover is moved from the fourth position (IV) to the third position (III) via the trigger, the icebreaker moves from the first position (I) to the second position (II). In order for the icebreaker to move from the first position (I) to the second position (II), the cover must be in the third position (III) in which it is open. In this way, the air received from the air inlet is transferred to the piston area through the air duct, and the icebreaker, which is pushed in the opposite direction of the air flow by the piston area, moves to the second position (II) such that the extensions protrude from the wing. In order for the icebreaker to move from the second position (II) to the first position (I), the cover must be in the fourth position (IV) in which it is closed. Therefore, air intake through the air inlet is prevented. When the power generated by the piston area disappears and/or decreases, a spring area enables the icebreaker to move from the second position (II) to the first position (I) in the direction of the air flow, that is, to retract. Thus, the icebreaker returns to the first position (I), which is the position where there are no extensions on the leading edge and where the extensions and openings form the same surface.

In an embodiment of the invention, the anti-icing system comprises a piston bearing extending from the wing; and a pin extending from the icebreaker. To mount the icebreaker inside the wing, the pin is movably inserted into the piston bearing. The movement of the pin along the piston bearing is carried out by air transferred through the air duct. There is a gasket around the pin to allow the air in the piston bearing to push the pin without leaking. A hole on the pin enables the evacuation of excess air, preventing the pin from disengaging from the piston bearing due to excess air, and allowing the air in the air duct to exit so that the icebreaker returns to the first position (I). There are piston bearing, pin, gasket and hole in the piston area.

In an embodiment of the invention, the anti-icing system comprises the spring mounted between the wing and icebreaker. One end of the spring is on the wing and the other end is on the icebreaker. The spring pin extending from the wing can move within a spring seat provided on the icebreaker. The icebreaker is mounted on the wing by inserting the spring pin into the spring seat, and when the spring seat is positioned in the spring, the icebreaker is enabled to move along the same direction while the spring brings the icebreaker to the first position (I).

In an embodiment of the invention, the anti-icing system comprises the steps that enable the icebreaker to move between the first position and the second position to mechanically break up the ice. The cover is opened by the trigger and moved to the third position, allowing air intake to the air duct through the air inlet. The air moving through the air duct is transferred to the piston area and pushes the pin in the piston bearing, allowing the icebreaker to move from the first position (I) to the second position (II). Thanks to the icebreaker moving from the first position (I) to the second position (II), the ice formed on the wing is broken. At the same time, a length of the spring increases and the spring pin moves by sliding in the spring seat. Excess air transferred to the piston area is evacuated through the gap to prevent the pin from disengaging from the piston seat. The cover, which is triggered by the trigger and brought to the fourth position (IV), closes the air inlet, preventing air intake into the air duct. When the air intake is prevented, the pulling force created by the spring in the spring area begins to overcome the pushing force in the piston area. Thus, the icebreaker starts to move from the second position to the first position. In this process, the air trapped in the piston area continues to be evacuated through the gap, the length of the spring shortens and the spring pin slides in the spring seat to be inserted in the spring seat. At the same time, the pin continues to be inserted into the piston bearing. These steps are carried out upon a command provided by the user to the control unit or automatically upon a command provided to the trigger by the control unit.

In an embodiment of the invention, the anti-icing system comprises the cover on the air inlet, with openings thereon to allow air to enter. Air is prevented from entering the air inlet with an apparatus on the air inlet, which extends adjacent to the cover in the same direction as the cover and covers the openings in the cover. The apparatus is located fixedly on the air inlet, with openings thereon. When the cover is brought by means of the trigger to the third position (III), i.e. the open position, air intake is provided through the openings in the apparatus located on the air inlet. When the cover is brought by means of the trigger to the fourth position (IV), i.e. the closed position, the openings on the cover and the openings on the apparatus do not correspond to each other, preventing air intake into the air inlet.

In an embodiment of the invention, the anti-icing system comprises the trigger made with a shape memory alloy. The trigger, preferably in a rod form, causes the cover to move in the direction it extends on the air inlet, when it cools. In this way, the gaps on the apparatus and the gaps on the cover remain at least partially opposite each other, allowing air intake into the air inlet.

In an embodiment of the invention, the anti-icing system comprises a temperature sensor that enables instantaneous measurement of the temperature on the wing. If the temperature sensor measures a temperature value lower than a temperature value specified by the user, a command for breaking the ice formed or being formed on the wing is transmitted by the control unit to the trigger located in the actuator mechanism, allowing the icebreaker to move from the first position (I) to the second position (II).

In an embodiment of the invention, the anti-icing system comprises a thickness sensor that enables instantaneous measurement of ice thickness on the wing. When the thickness sensor measures a thickness value lower than an ice thickness value specified by the user, a command for breaking the ice formed on the wing is transmitted by the control unit to the trigger located in the actuator mechanism, allowing the icebreaker to move from the first position (I) to the second position (II).

In an embodiment of the invention, the anti-icing system comprises the air duct with a cross-sectional area narrowing away from the air inlet, so that the air moves faster while moving away from the air inlet, and is transmitted to the piston areas located away from the air inlet on the wing. Since the air duct has a narrowing form, air reaches the piston areas in the area far from the air inlet quickly, and the piston areas make pushing movement almost simultaneously as the icebreaker moves from the first position (I) to the second position (II).

In an embodiment of the invention, the anti-icing system comprises the piston bearing, with a volume narrowing away from the air inlet. When the air intake capacity of the piston bearing decreases, the piston areas in the area far from the air inlet make the pushing movement almost completely simultaneously with the piston areas in the area close to the air inlet, with less air flow, while the icebreaker moves from the first position (I) to the second position (II).

In an embodiment of the invention, the anti-icing system comprises wind turbine wing, helicopter wing or airplane wing.

In an embodiment of the invention, the anti-icing system comprises the rotor shaft located at the body of the helicopter or the wind turbine; the air inlet located close to the rotor shaft on multiple wings connected to the rotor shaft. Since the air inlet is close to the rotor shaft, if the trigger is made of a metal or shape memory alloy, the cover will move faster to allow air to enter through the air inlet, thus triggering the icebreaker. The icebreaker is preferably enabled to move to a place where the rotation speed is lower, and therefore the icing is expected to be denser.

The anti-icing system realized to achieve the object of the present invention is illustrated in the attached drawings, in which:

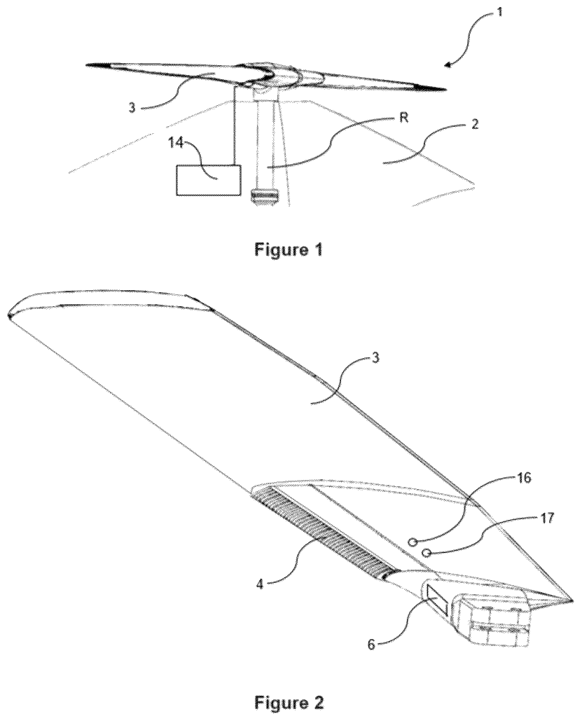

FIG. 1 is a schematic view of the anti-icing system.

FIG. 2 is a perspective view of the wing and icebreaker in the second position (II).

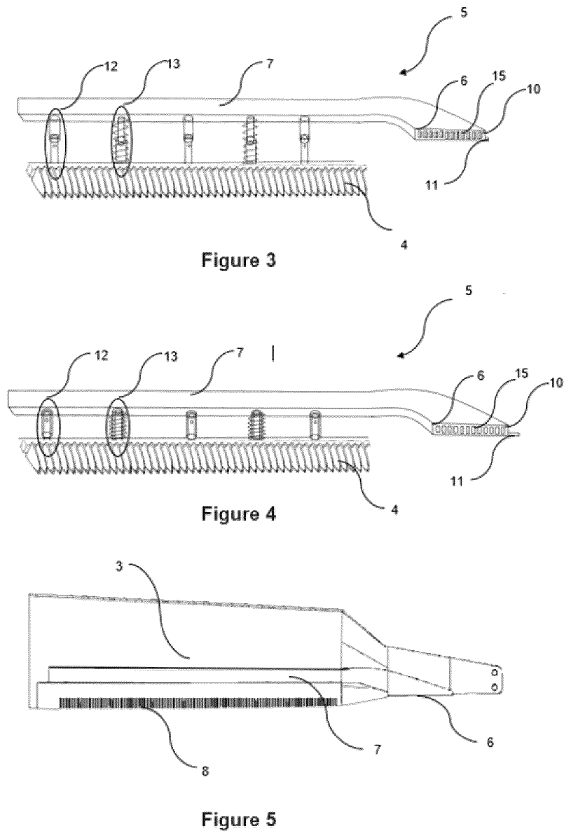

FIG. 3 is a perspective view of the icebreaker in the second position (II) and the cover in the third position (III).

FIG. 4 is a perspective view of the icebreaker in the first position (I) and the cover in the fourth position (IV).

FIG. 5 is a top view of the wing, icebreaker, air inlet and air duct.

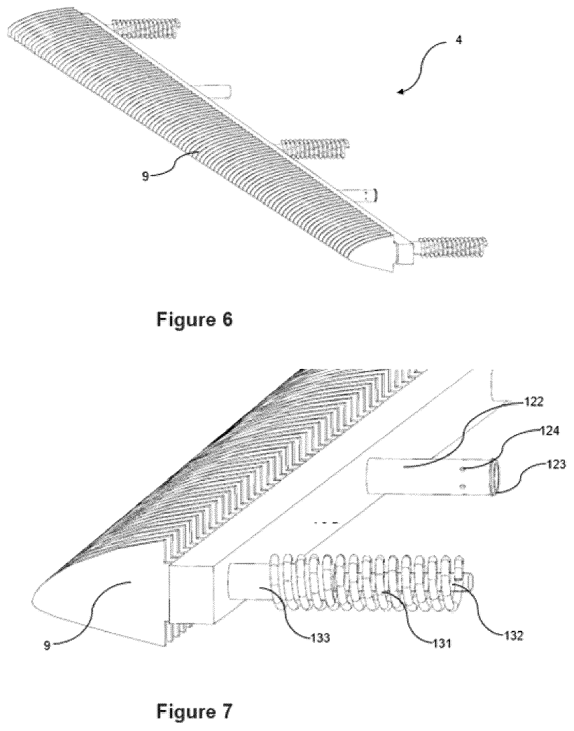

FIG. 6 is a perspective view of the icebreaker.

FIG. 7 is a side view of the spring area.

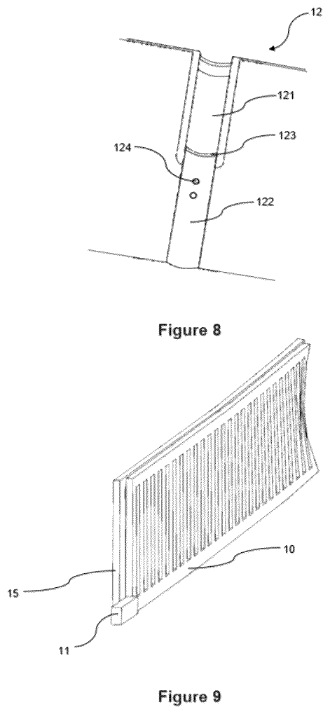

FIG. 8 is a perspective view of the piston area.

FIG. 9 is a perspective view of the cover, apparatus and trigger.

All the parts illustrated in figures are individually assigned a reference numeral and the corresponding terms of these numbers are listed below:
1. Anti-icing system
2. Body
3. Wing
4. Icebreaker
5. Actuator mechanism
6. Air inlet
7. Air duct
8. Opening
9. Extension
10. Cover
11. Trigger
12. Piston area
   121. Piston bearing
   122. Pin
   123. Gasket
   124. Hole
13. Spring area
   131. Spring
   132. Spring pin
   133. Spring seat
14. Control unit
15. Apparatus
16. Thickness sensor
   (I) First position
   (II) Second position
   (III) Third position
   (IV) Fourth position
   (R) Rotor shaft

The anti-icing system (1) comprises a body (2); at least one wing (3) located on the body (2); at least one icebreaker (4) on the wing (3), which enables the ice formed on the wing (3) surface to be removed from the wing (3) surface; an actuator mechanism (5) that enables the icebreaker (4) to move on the wing (3).

The anti-icing system (1) according to the invention comprises a first position (I) of the icebreaker (4), in which the icebreaker (4) is mounted within and/or above and/or below the leading edge of the wing (3) and/or within the contact surface; a second position (II) to which the icebreaker (4) is brought by moving outwards from the leading edge of the wing (3) in order to break the ice accumulated on the surface of the wing (3); an air inlet (6) located as an opening on the wing (3) and allowing air intake from the atmosphere; at least one air duct (7) that enables the air received through the air inlet (6) to be transmitted in the wing (3), thus allowing the icebreaker (4) to move between the first position (I) and the second position (II); the actuator mechanism (5) consisting of air inlet (6) and air duct (7).

Ice formation can occur on the wing (3) connected to a body (2), as the moisture in the air cools and solidifies. There is at least one icebreaker (4) triggered by the actuator mechanism (5) to remove the ice on the wing (3).

There is a first position (I) of the icebreaker (4), in which the icebreaker (4) is mounted within and/or above and/or below the leading edge of the wing (3) and/or within the contact surface; and a second position (II) in which the icebreaker (4) extends outwards from the leading edge of the wing (3). Thanks to the icebreaker (4) moving between the first position (I) and the second position (II), the ice formed on the wing (3) is mechanically broken apart and removed from the wing (3) with the drag force. The icebreaker (4) can move from the first position (I) to the second position (II) or from the second position (II) to the first position (I) thanks to the actuator mechanism (5) consisting of the air inlet (6) and the air duct (7). The air received through the air inlet (6) is conveyed by the air duct (7) to move the icebreaker (4). The icebreaker (4) moves between the first position (I) and the second position (II) according to the air flow. When the air flow rate received through the air inlet (6) is above a threshold value determined by the user, the air conveyed by the air duct (7) can move the icebreaker (4) towards the second position (II). Therefore, the ice is broken. When the air flow rate received through the air inlet (6) is lower than the threshold value determined by the user, the air conveyed by the air duct (7) cannot activate the icebreaker (4), such that the icebreaker (4) remains in the first position (I) (FIG. 2).

In an embodiment of the invention, the anti-icing system (1) comprises a plurality of openings (8) located consecutively on the leading edge of the wing (3); a plurality of extensions (9) located on the icebreaker (4), facing each of the openings (8) on the wing (3); the first position (I) to which the icebreaker (4) is moved by positioning the extensions (9) to cover each opening (8) on the wing (3); the second position (II) to which the icebreaker (4) is moved when the extensions (9) extend outwards from the leading edge of the wing (3) upon movement of the icebreaker (4) on the wing (3). The extensions (9) extending from the icebreaker (4) form a comb form. When the extensions (9) are almost completely inside the openings (8), the icebreaker (4) is located in the first position (I) within the wing (3). If the ice is to be broken, the icebreaker (4) extends from the wing (3), so that the extensions (9) create a structurally larger aerodynamic surface on the wing (3). In this way, the leading edge of the wing (3) expands to break the ice (FIG. 6).

In an embodiment of the invention, the anti-icing system (1) comprises a cover (10) on the air inlet (6), which allows control of the air intake transferred to the air duct (7), in order to break the ice on the wing (3); a trigger (11) that enables the cover (10) to be opened or closed; the cover (10) which is brought by the trigger (11) to the open position in which the air is allowed to enter through the air inlet (6), thus allowing the icebreaker (4) to be moved from the first position (I) to the second position (II) to break the ice; the cover (10) which is brought to the closed position by means of the trigger (11), thus allowing the icebreaker (4) to be moved from the second position (II) to the first position (I). In order to move the icebreaker (4) between the first position (I) and the second position (II), the flow rate of the air received in by the air inlet (6) and transferred through the air duct (7) must be controlled. Thus, a cover (10) is provided on the air inlet (6). When the cover (10) closes the air inlet (6), there is no air intake into the air duct (7), so the icebreaker (7) is located in the wing (3), i.e. in the first position (I). When the cover (10) is opened by means of the trigger (11), the air inlet (6) allows air intake, such that the air through the air inlet (6) moves along the air duct (7). The air in the air duct (7) enables the icebreaker (4) to move from the first position (I) to the second position (II), thus breaking the ice (FIG. 3, FIG. 4).

In an embodiment of the invention, the anti-icing system (1) comprises a third position (III) in which the cover (10) is opened by means of the trigger (11) in order to bring the icebreaker (4) to the second position (II) to break the ice; a fourth position (IV) in which the cover (10) is closed by means of the trigger (11) to prevent air intake into the air duct (7); at least one piston area (12) on the actuator mechanism (5), which enables the icebreaker (4) to move from the first position (I) to the second position (II) when triggered by the air transferred to the air duct (7), while the cover (10) is in the third position (III); at least one spring area (13) on the actuator mechanism (5), which enables the icebreaker (4) to move from the second position (II) to the first position (I) since the air transferred to the air duct (7) is prevented while the cover (10) is in the fourth position (IV). In order for the icebreaker (4) to break the ice formed on the wing (3), it must be moved from the first position (I) to the second position (II). When the cover (10) in the actuator mechanism (5) is opened by means of the trigger (11), which is also in the actuator mechanism (5), the cover (3) is positioned in the third position (III). Air intake is provided through air inlet (6) by the cover (10) brought to the third position (III) according to the command transmitted from the trigger (11), and since the air received through the air inlet (6) is transferred to the piston area (12) by means of the air duct (7), the icebreaker (4) is pushed, causing the icebreaker (4) on the leading edge of the wing (3) to move outward so as to extend out from the leading edge of the wing (3), that is, to move from the first position (I) to the second position (II). Since the cover (10) is brought by the trigger (11) to the fourth position (IV) where it is closed, the air received through the air inlet (6) is prevented, and when the pulling force of the spring area (13) overcomes the pushing force of the piston area (12), the icebreaker (4) moves back from the second position (II) to the first position (I) where it is located in the leading edge of the wing (3). Therefore, the ice formed on the surface of the wing (3) is mechanically broken and aerodynamically rough surfaces are prevented (FIG. 3, FIG. 4).

In an embodiment of the invention, the anti-icing system (1) comprises at least one piston bearing (121) extending from the wing (3) and enabling the icebreaker (4) to be mounted on the wing (3); at least one pin (122) which extends outward from the ice breaker (4) and which can move into the piston bearing (121) due to the control of the air flow rate transferred through the air duct (7); at least one gasket (123) on the pin (122), which enables air tightness during the movement of the pin (122) in the piston bearing (121); at least one hole (124) on the pin (122), which enables the evacuation of air received through the air inlet (6); the piston area (12) consisting of the piston bearing (121), pin (122), gasket (123) and hole (124). The pin (122) extending from the icebreaker (4) is inserted into the piston bearing (121) extending from the wing (3), so as to be movable along the piston bearing (121). In this way, the icebreaker (4) can be mounted on the leading edge of the wing (3). The pin (122) moves in the piston bearing (121) thanks to the air transferred through the air duct (7). When the cover (10) is opened and air flow is created beyond the air duct (7), the pin (122) located in the piston area (12) is pushed from the piston bearing (121), allowing the icebreaker (4) to move from the first position (I) to the second position (II). The gasket (123) located around the pin (122) and in the piston area (12) prevents air leakage while the pin (122) is pushed by air. The hole (124) located on the pin (122) and in the piston area (12) enables the evacuation of excess air received through the air duct (7), and enables the air remaining therein to be evacuated while the icebreaker (4) moves from the second position (4) to the first position (I) (FIG. 3, FIG. 4, FIG. 8).

In an embodiment of the invention, the anti-icing system (1) comprises at least one spring (131), with one end mounted on the wing (3) and the other end on the icebreaker (4), which is compressed when the icebreaker (4) is in the second position (II), enabling the icebreaker (4) to be moved to the first position (I); at least one spring pin (132) located in the spring (131) and extending from the wing (3); at least one spring seat (133) in the spring (131), within which the spring pin (132) can move, thus allowing the spring pin (132) to be contained; the spring area (13) consisting of the spring (131), spring pin (132) and spring seat (133). Thanks to the spring (131) located between the wing (3) and the icebreaker (4), the icebreaker (4) is enabled to move from the second position (II) to the first position (I), when the cover (10) is in the fourth position (IV) in which it is closed. At the same time, the icebreaker (4) is pulled towards the wing (3) by the spring (131), which is compressed and shortened in length. The spring pin (132) extending from the wing (3) is located in the spring seat (133) provided on the icebreaker (4), movably along the spring seat (133). The spring pin (132) is inserted into the spring seat (133), and the spring seat (133) is located in the spring (131). Thus, as the icebreaker (4) moves from the second position (II) to the first position (I), the spring (131), which provides the pulling force, is aligned with the spring pin (132) located in the spring seat (133). Thanks to the spring (131), spring pin (132) and spring seat (133) that are located in the spring area (13), the icebreaker (4) is enabled to move from the second position (II) to the first position (I) (FIG. 3, FIG. 4, FIG. 7).

In an embodiment of the invention, the anti-icing system (1) comprises a control unit (14) that moves the icebreaker (4) between the first position (I) and the second position (II) to enable the ice formed on the wing (3) to be broken, by the steps of:
Providing the air inlet (6) in the third position (III) in which it is open, when the cover (10) on the air inlet (6) is triggered by the trigger (11);
Providing air intake from the atmosphere through the air inlet (6);
Transferring the air received from the atmosphere to the piston area (12) via the air duct (7);
When the transferred air pushes the pin (122) in the piston bearing (121), moving the icebreaker (4) from the first position (I) to the second position (II) on the wing (3) to break the ice;
Providing the air inlet (6) in the fourth position (IV) in which it is closed, when the cover (10) on the air inlet (6) is triggered by the trigger (11);
Evacuating the excess air through the hole (124);
Moving the icebreaker (4), which is pulled towards the wing (3) by the spring (131), from the second position (II) to the first position (I), and simultaneously moving the spring pin (132) in the spring seat (133).
   Therefore, the ice on the leading edge of the wing (3) is broken by the icebreaker (4) moving between the first position (I) and the second position (II).

In an embodiment of the invention, the anti-icing system (1) comprises the cover (10) which is movably located on the air inlet (6), with gaps thereon allowing air intake; an apparatus (15) that is fixed on the air inlet (6) so as to cover the gaps in the cover (10), thus preventing air intake; the trigger (11) which enables the cover (10) to slide on the axis it extends, thus allowing air intake through the gaps in the apparatus (15). There is a cover (10) that is movable on the air inlet (6), with gaps thereon; and an apparatus (15) that is fixed on the air inlet (6), with gaps thereon. The apparatus (15) and the cover (10) are located adjacent to each other. When the gaps on the cover (10) do not correspond to the gaps in the adjacent apparatus, air intake into the air inlet (6) is prevented. The cover (10) and the apparatus (15) can preferably be in the form of a ladder. Thus, in order to prevent air intake through the air inlet (6), the gap above one is completed with the part above the other. Thanks to the movement of the cover (10) by means of the trigger (11), air intake is provided to the air inlet (6) through the gaps of the fixed apparatus (15) (FIG. 9).

In an embodiment of the invention, the anti-icing system (1) comprises the trigger (11) in the form of a rod made of a shape memory alloy, which enables the cover (10) to be triggered. When the weather is cold, the length of the trigger (11) made of a shape memory alloy is decreased, so that air intake is provided through the gaps on the apparatus (15). In this way, the cover (10) can be moved between the third position (III) and the fourth position (IV) at the desired temperature by means of the trigger (11), which can be made of different types of shape memory alloys.

In an embodiment of the invention, the anti-icing system (1) comprises at least one temperature sensor (16) on the wing (3) for measuring the temperature; the control unit (14) that transmits a command to the trigger (11) to move the cover (10) from the fourth position (IV) to the third position (III) when the data obtained by the temperature sensor (16) is below a temperature threshold value determined by the user. The temperature on the wing (3) is measured instantly with the temperature sensor (16) such that, when the instantaneous temperature is lower than the threshold value determined by the user according to the ice formation temperature, a signal is transmitted by the control unit (14) to the trigger (11) to move the cover (10) from the fourth position (IV), i.e. the closed position, to the third position (III), i.e. the open position. Thus, the icebreaker (4) is enabled to break the potential ice or the ice that has formed, depending on the wing temperature.

In an embodiment of the invention, the anti-icing system (1) comprises at least one thickness sensor (17) on the wing (3) for measuring an ice thickness; the control unit (14) that transmits a command to the trigger (11) to move the cover (10) from the fourth position (IV) to the third position (III) when the data obtained by the thickness sensor (17) is above a thickness threshold value determined by the user. The ice thickness value on the wing (3) is measured instantly by the thickness sensor (17). The measured thickness value may cause danger due to the amount of roughness on the aerodynamic surface. Therefore, when the instantly measured thickness is greater than the ice thickness determined by the user, a signal is transmitted by the control unit (14) to the trigger (11) to move the cover (10) from the fourth position (IV), i.e. closed position, to the third position (III), i.e. the open position. Thus, the icebreaker (4) is enabled to break the potential ice or the ice that has formed, depending on the wing temperature.

In an embodiment of the invention, the anti-icing system (1) comprises the air duct (7) with a cross-sectional area narrowing away from the air inlet (6) in order to increase the flow rate of the air. By accelerating the air transferred through the air duct (7), due to the narrowing structure of the air duct (7), the piston area (12) located away from the air inlet (6) and the piston area (12) located closer, are triggered nearly at the same time. The icebreaker (4) moves from the first position (I) to the second position (II) by the piston areas (12) triggered almost simultaneously.

In an embodiment of the invention, the anti-icing system (1) comprises the piston bearing (121) which becomes narrower away from the air inlet (6) compared to the previous one, in order to reduce the air intake capacity. The air intake capacity of the piston bearing (121) located away from the air inlet (6) is designed to be lower than the air intake capacity of the piston bearing (121) located closer to the air inlet (6). Therefore, as the distance from the air inlet (6) increases, the air intake capacity of the piston bearing (121) decreases, and the distant piston bearing (121), which is provided with late transfer by the air duct (7), is enabled to be filled with air more quickly, and triggers the pin (122) almost simultaneously with respect to the closer one. In this way, the icebreaker (4) is enabled to move from the first position (I) to the second position (II) with the piston areas (12) triggered almost simultaneously.

In an embodiment of the invention, the anti-icing system (1) comprises the wing (3) on a wind turbine, helicopter or airplane. The icebreaker (4) can be mounted on any wing (3) on the wind turbine, helicopter or airplane body (2).

In an embodiment of the invention, the anti-icing system (1) comprises a rotor shaft (R) located on the body (2) rotatable around its own axis; the air inlet (6) which is an opening on the leading edge of the wing (3), close to the rotor shaft (R) with the lowest rotational speed for the wing (3) connected to the rotor shaft (R) to rotate around the rotor shaft (R). An air inlet (6) is added on the wing (3) in order to use the rotational movement of the rotor shaft (R). Compressed air is obtained by positioning the air inlet (6) facing the rotational direction of the rotor shaft (R), the air inlet (6) facing the rotational direction of the rotor shaft (R) pressurizes the air towards the air ducts (7) under the effect of drag force, and the air in the air ducts (7) inside the wing (3) moves the icebreaker (4) between the first position (I) and the second position (II) with the effect of the centrifugal force obtained by the rotation of the rotor shaft (R). The air pressure and flow rate reaching the air inlet (6) on the wing (3) increases as the wing (3) rotates in the movement direction of the air vehicle, and decreases when the wing (3) rotates in the opposite direction to the movement direction of the air vehicle. This helps the icebreaker (4), which will de-ice the wing (3), to function efficiently (FIG. 1).

1. An assembly comprising a body (2); at least one wing (3) located on the body (2); at least one icebreaker (4) on the wing (3), which enables the ice formed on the wing (3) surface to be removed from the wing (3) surface; an actuator mechanism (5) that enables the icebreaker (4) to move on the wing (3), at least one spring area (13) wherein a first position (I) of the icebreaker (4), in which the icebreaker (4) is mounted within and/or above and/or below the leading edge of the wing (3); a second position (II) to which the icebreaker (4) is brought by moving outwards from the leading edge of the wing (3) in order to break the ice accumulated on the surface of the wing (3); an air inlet (6) located as an opening on the wing (3) and allowing air intake from the atmosphere; at least one air duct (7) that enables the air received through the air inlet (6) to be transmitted in the wing (3), thus allowing the icebreaker (4) to move between the first position (I) and the second position (II); the actuator mechanism (5) consisting of air inlet (6) and air duct (7).

2. An assembly according to claim 1, wherein a plurality of openings (8) located consecutively on the leading edge of the wing (3); a plurality of extensions (9) located on the icebreaker (4), facing each of the openings (8) on the wing (3); the first position (I) to which the icebreaker (4) is moved by positioning the extensions (9) to cover each opening (8) on the wing (3); the second position (II) to which the icebreaker (4) is moved when the extensions (9) extend outwards from the leading edge of the wing (3) upon movement of the icebreaker (4) on the wing (3).

3. An assembly according to claim 1, wherein a cover (10) on the air inlet (6), which allows control of the air intake transferred to the air duct (7), in order to break the ice on the wing (3); a trigger (11) that enables the cover (10) to be opened or closed; the cover (10) which is brought by the trigger (11) to the open position in which the air is allowed to enter through the air inlet (6), thus allowing the icebreaker (4) to be moved from the first position (I) to the second position (II) to break the ice; the cover (10) which is brought to the closed position by means of the trigger (11), thus allowing the icebreaker (4) to be moved from the second position (II) to the first position (I).

4. An assembly according to claim 1, wherein a third position (III) in which the cover (10) is opened by means of the trigger (11) in order to bring the icebreaker (4) to the second position (II) to break the ice; a fourth position (IV) in which the cover (10) is closed by means of the trigger (11) to prevent air intake into the air duct (7); at least one piston area (12) on the actuator mechanism (5), which enables the icebreaker (4) to move from the first position (I) to the second position (II) when triggered by the air transferred to the air duct (7), while the cover (10) is in the third position (III); at least one spring area (13) on the actuator mechanism (5), which enables the icebreaker (4) to move from the second position (II) to the first position (I) since the air transferred to the air duct (7) is prevented while the cover (10) is in the fourth position (IV).

5. An assembly according to claim 1, wherein at least one piston bearing (121) extending from the wing (3) and enabling the icebreaker (4) to be mounted on the wing (3); at least one pin (122) which extends outward from the ice breaker (4) and which can move into the piston bearing (121) due to the control of the air flow rate transferred through the air duct (7); at least one gasket (123) on the pin (122), which enables air tightness during the movement of the pin (122) in the piston bearing (121); at least one hole (124) on the pin (122), which enables the evacuation of air received through the air inlet (6); the piston area (12) consisting of the piston bearing (121), pin (122), gasket (123) and hole (124).

6. An assembly according to claim 1, wherein at least one spring (131), with one end mounted on the wing (3) and the other end on the icebreaker (4), which is compressed when the icebreaker (4) is in the second position (II), enabling the icebreaker (4) to be moved to the first position (I); at least one spring pin (132) located in the spring (131) and extending from the wing (3); at least one spring seat (133) in the spring (131), within which the spring pin (132) can move, thus allowing the spring pin (132) to be contained; the spring area (13) consisting of the spring (131), spring pin (132) and spring seat (133).

7. An anti-icing method, wherein a control unit (14) that configured to moves the icebreaker (4) between the first position (I) and the second position (II) to enable the ice formed on the wing (3) to be broken, by the steps of:
Providing the air inlet (6) in the third position (III) in which it is open, when the cover (10) on the air inlet (6) is triggered by the trigger (11);
Providing air intake from the atmosphere through the air inlet (6);
Transferring the air received from the atmosphere to the piston area (12) via the air duct (7);
When the transferred air pushes the pin (122) in the piston bearing (121), moving the icebreaker (4) from the first position (I) to the second position (II) on the wing (3) to break the ice;
Providing the air inlet (6) in the fourth position (IV) in which it is closed, when the cover (10) on the air inlet (6) is triggered by the trigger (11);
Evacuating the excess air through the hole (124);
Moving the icebreaker (4), which is pulled towards the wing (3) by the spring (131), from the second position (II) to the first position (I), and simultaneously moving the spring pin (132) in the spring seat (133).

8. An assembly according to claim 3, wherein the cover (10) which is movably located on the air inlet (6), with gaps thereon allowing air intake; an apparatus (15) that is fixed on the air inlet (6) so as to cover the gaps in the cover (10), thus preventing air intake; the trigger (11) which enables the cover (10) to slide on the axis it extends, thus allowing air intake through the gaps in the apparatus (15).

9. An assembly according to claim 3, wherein the trigger (11) in the form of a rod made of a shape memory alloy, which enables the cover (10) to be triggered.

10. An assembly according to claim 3, wherein at least one temperature sensor (16) on the wing (3) for configured to measuring the temperature; the control unit (14) that transmits a command to the trigger (11) to move the cover (10) from the fourth position (IV) to the third position (III) when the data obtained by the temperature sensor (16) is below a temperature threshold value determined by the user.

11. An assembly according to claim 3, wherein at least one thickness sensor (17) on the wing (3) for configured to measuring an ice thickness; the control unit (14) that transmits a command to the trigger (11) to move the cover (10) from the fourth position (IV) to the third position (III) when the data obtained by the thickness sensor (17) is above a thickness threshold value determined by the user.

12. An assembly according to claim 1, wherein the air duct (7) with a cross-sectional area narrowing away from the air inlet (6) in order to increase the flow rate of the air.

13. An assembly according to claim 5, wherein the piston bearing (121) becoming narrower as it moves away from the air inlet (6) compared to the piston bearing (121) closer to the air inlet, in order to reduce the air intake capacity.

14. An assembly according to claim 1, wherein the wing is a wing of a wind turbine, helicopter or airplane.

15. An assembly according to claim 1, wherein a rotor shaft (R) located on the body (2) rotatable around its own axis; the air inlet (6) which is an opening on the leading edge of the wing (3), close to the rotor shaft (R) with the lowest rotational speed for the wing (3) connected to the rotor shaft (R) to rotate around the rotor shaft (R).
